(19) United States
(12) Patent Application Publication
(10) Pub. No.: US 2013/0319606 A1
(43) Pub. Date: Dec. 5, 2013

(54) FILM PASTING DEVICE AND METHOD

(71) Applicants: Bin Guo, WuJiang Economic-Technological Developme (CN); Wei Huang, WuJiang Economic-Technological Developme (CN); Ching-Feng Hsieh, Taipei (TW)

(72) Inventors: Bin Guo, WuJiang Economic-Technological Developme (CN); Wei Huang, WuJiang Economic-Technological Developme (CN); Ching-Feng Hsieh, Taipei (TW)

(73) Assignees: ASKEY COMPUTER CORPORATION, New Taipei City (TW); ASKEY TECHNOLOGY (JIANGSU) LTD., WuJiang Economic-Technological Developme (CN)

(21) Appl. No.: 13/482,610

(22) Filed: May 29, 2012

(51) Int. Cl. B32B 37/10; B32B 37/12

(52) U.S. Cl. 156/247; 156/580; 156/60

(57) ABSTRACT

A film pasting device and method for pasting a circuit board and a dome array together are disclosed. The device includes: a carrier having at least a suction hole, a support member connected to the carrier and having a plurality of air holes, a suction member connected to the carrier, and a first positioning member disposed on the carrier. The film pasting device includes: positioning the dome array, providing a suction force for sucking the dome array so as to evenly dispose the dome array, disposing the circuit board on the dome array, and providing a pressing force to press the circuit board to the dome array. Therefore, the present invention overcomes the conventional difficulty of aligning the dome array with the circuit board, thereby improving the product yield.

### BACKGROUND OF THE INVENTION

1. Field of the Invention

The present invention relates to film pasting technologies, and, more particularly, to a film pasting device and a method for pasting a circuit board and a dome array together.

2. Description of Related Art

In an electronic product, such as a mobile phone, a digital camera, a remote controller, a digital dictionary and so on, a dome array is provided between key pads of a control panel and an internal circuit board so as for the key pads to come into contact with the internal circuit board for operation.

Generally, the dome array is a plastic film with a plurality of metal dome contacts. The plastic film has an adhesive surface which is covered by a layer of release paper. The metal dome contacts are disposed over a conductive area of the circuit board and corresponding to the key pads of the electronic device. When one of the key pads is pressed, the corresponding metal dome contact is pressed downward so as to come into contact with the conductive area of the circuit board, thereby forming a closed loop for electrical current to flow through. Therefore, the dome array functions as a switch between the user and the electronic device. Therefore, the pasting process for pasting the dome array and the circuit board together has a great impact on the operation performance of the electronic device.

Conventionally, a portion of the release paper is removed first from the dome array so as to expose a portion of the adhesive surface and then the edges of the exposed portion are aligned with the circuit board. Further, the dome array is spread and pasted to the circuit board while the remaining portion of the release paper is removed. As such, the dome array is completely pasted to the circuit board when the release paper is completely removed.

However, the conventional pasting process has some drawbacks. For example, since it is difficult to precisely align the dome array with the circuit board, when a key pad is pressed, a poor contact may occur between the corresponding metal dome contact and the conductive area of the circuit board, thus reducing the product yield. Further, since the dome array is adhesive, if it is exposed to air for a long time, unwanted objects can be easily attached between the dome array and the circuit board.

Therefore, there is a need to provide a film pasting device and method so as to overcome the above-described drawbacks.

### SUMMARY OF THE INVENTION

In view of the above-described drawbacks, present invention provides a film pasting device and method so as to overcome the conventional difficulty of aligning a dome array with a circuit board.

Another object of the present invention is to provide a film pasting device and method so as to prevent the dome array from being exposed to air for a long time.

In order to achieve the above and other objects, the present invention provides a film pasting device for pasting a circuit board and a dome array together, which comprises: a carrier having at least a suction hole; a support member connected to the carrier so as for the dome array to be disposed thereon, wherein the support member has a plurality of air holes; a suction member connected to the carrier for providing a suction force that sucks the dome array through the at least one suction hole of the carrier and the air holes of the support member such that the dome array is evenly disposed on the support member, thereby allowing the circuit board to be evenly attached to the dome array; and a first positioning member disposed on the carrier, wherein a pressing force is provided to press the circuit board to the dome array and when the pressing force is removed, the first positioning member provides an elastic restoring force so as to separate the dome array and the circuit board from the support member.

The film pasting device may further comprise an actuating member that provides the pressing force for pressing the circuit board to the dome array.

The film pasting device may further comprise at least a second positioning member disposed on the carrier and having elasticity, and at least a second positioning portion disposed on the support member and corresponding to the second positioning member.

Further, the dome array may have a first positioning hole and a second positioning hole corresponding to the first positioning member and the second positioning member, respectively, so as to position the dome array on the support member.

The circuit board may further have a first positioning hole and a second positioning hole corresponding to the first positioning member and the second positioning member, respectively, so as to position the circuit board on the dome array.

In an embodiment, the first positioning hole of the dome array is greater than the first positioning hole of the circuit board, and the second positioning hole of the dome array is greater than the second positioning hole of the circuit board.

The present invention further provides a film pasting method for pasting a circuit board and a dome array together, which comprises the steps of: (1) positioning the dome array; (2) providing a suction force for sucking the dome array so as to evenly dispose the dome array; (3) disposing the circuit board on the dome array; and (4) providing a pressing force so as to press the circuit board to the dome array.

In an embodiment, the dome array has an adhesive surface covered with a release layer, and step (2) further comprises removing the release layer to expose the adhesive surface.

According to the present invention, the dome array is first positioned through the first positioning member and evenly disposed on the support member by a suction force provided by the suction member. Then, the circuit board is disposed on the dome array and further pressed to the dome array through a pressing force. When the pressing force is removed, the dome array and the circuit board are separated from the support member through an elastic restoring force provided by the first positioning member. As such, the dome array and the circuit board are precisely aligned to each other and pasted together. Further, the amount of time the adhesive surface of the dome array is exposed to air is shortened to thereby prevent unwanted objects from being attached between the dome array and the circuit board. Therefore, the present invention improves the operation performance and increases the product yield.

### BRIEF DESCRIPTION OF DRAWINGS

FIG. 1 is a schematic structural view of a film pasting device according to the present invention; and

FIGS. 2A to 2F are schematic views showing a film pasting method according to the present invention.

### DETAILED DESCRIPTION OF PREFERRED EMBODIMENTS

The following illustrative embodiments are provided to illustrate the disclosure of the present invention, these and other advantages and effects can be apparent to those in the art after reading this specification.

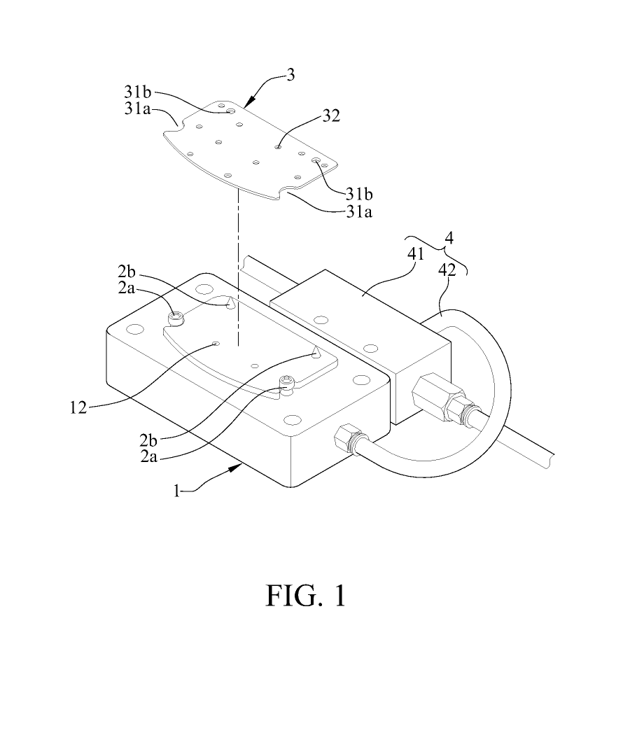

FIG. 1 shows a film pasting device for pasting a circuit board and a dome array together according to the present invention. Referring to FIG. 1, the film pasting device comprises a carrier 1, a first positioning member 2a, a support member 3 and a suction member 4.

Referring to FIG. 1, the carrier 1 has at least a suction hole 12. Further, the carrier 1 is step-shaped, but it is not limited thereto.

The first positioning member 2a is disposed on the carrier 1 and has elasticity for providing an elastic force to the dome array and the circuit board. The first positioning member 2a can be screwingly connected to or integrally formed with the carrier 1. The pasting device can further have a second positioning member 2b disposed on the carrier 1 and having elasticity. Similarly, the second positioning member 2b can be screwingly connected to or integrally formed with the carrier 1. In an embodiment, the first and second positioning members 2a and 2b are cone-shaped elastic positioning columns that are slightly different from each other. But it should be noted that the present invention is not limited thereto. The present invention can provide at least one first positioning member 2a or at least one second positioning member 2b so as to position the dome array and the circuit board. In addition, the cone shape of the positioning member facilitates subsequent pressing and separating processes.

The support member 3 is connected to the carrier 1 so as for the dome array to be disposed thereon. The support member 3 has a plurality of air holes 32 and at least a first positioning portion 31a corresponding to the first positioning member 2a. As such, the support member 3 is positioned on the carrier 1 by mutual engagement of the first positioning portion 31a and the first positioning member 2a. The support member 3 can further have at least a second positioning portion 31b corresponding to the second positioning member 2b so as to position the support member 3 on the carrier 1 through mutual engagement of the second positioning portion 31b and the second positioning member 2b. In an embodiment, the support member 3 is made of, for example, elastic foam, and the first and second positioning portions 31a, 31b are positioning holes or notches. But it should be noted that the present invention is not limited thereto. Furthermore, the dome array (not shown) has positioning holes corresponding to the first and/or second positioning members 2a, 2b such that the dome array is disposed on the support member 3 with its positioning holes engaging with the first and/or second positioning members 2a, 2b.

The suction member 4 is connected to the carrier 1 for providing a suction force. The suction member 4 has a suction valve 41 and an air pipe 42, and the suction valve 41 is connected to the carrier 1 through the air pipe 42. The suction force provided by the suction member 4 sucks the dome array through the at least one suction hole 12 of the carrier 1 and the plurality of air holes 32 of the support member 3 so as for the dome array to be evenly disposed on the support member 3, thereby allowing the circuit board (not shown) to be evenly attached to the dome array. The circuit board can have positioning holes corresponding to the first and/or second positioning members 2a, 2b such that the circuit board is disposed on the dome array with its positioning holes engaging with the first and/or second positioning members 2a, 2b. The positioning holes of the dome array are greater than those of the circuit board.

The film pasting device can further have an actuating member. After the dome array is disposed on the support member 3 and the circuit board is further disposed on the dome array, a pressing force is provided by the actuating member so as to press the circuit board to the dome array, thereby overcoming the conventional drawback of uneven manual force during a manual pressing process. Also, after the actuating member is removed from the circuit board, since the first and second positioning members 2a, 2b are elastic and the positioning holes of the dome array are greater than those of the circuit board, an elastic restoring force provided by the positioning members drives the dome array and the circuit board to move up. Therefore, the dome array and the circuit board are separated from the support member 3.

In practice, the carrier 1, the first positioning member 2a, the support member 2, the suction member 3 and the actuating member are disposed on a work platform that has a control switch for controlling on and off of the suction member 4. Furthermore, the shape and area of the support member 3 are substantially the same as those of the dome array and the circuit board.

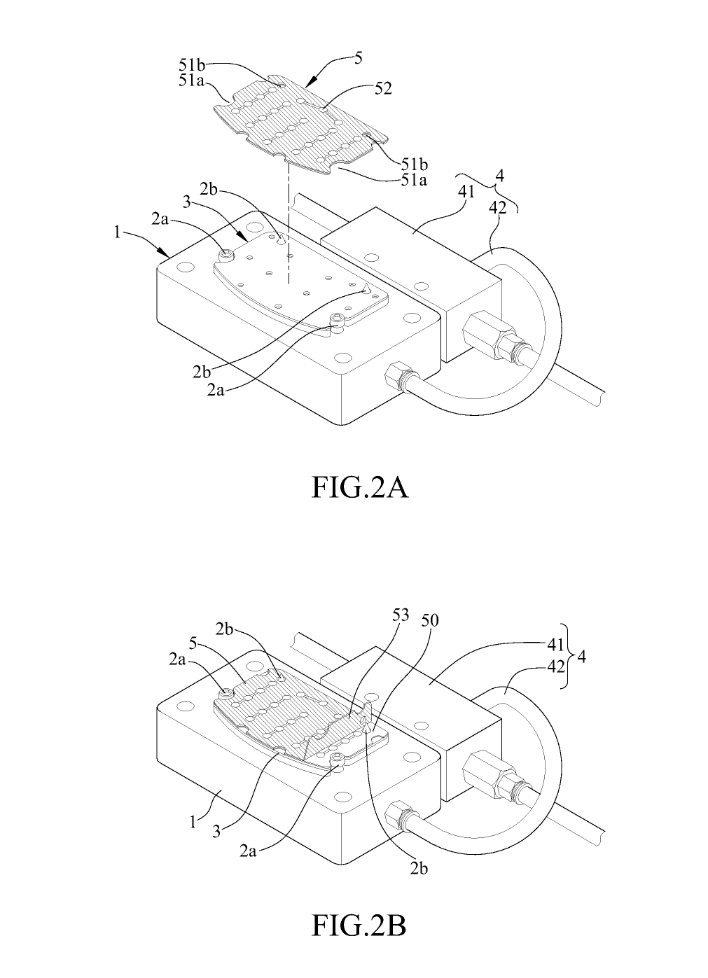

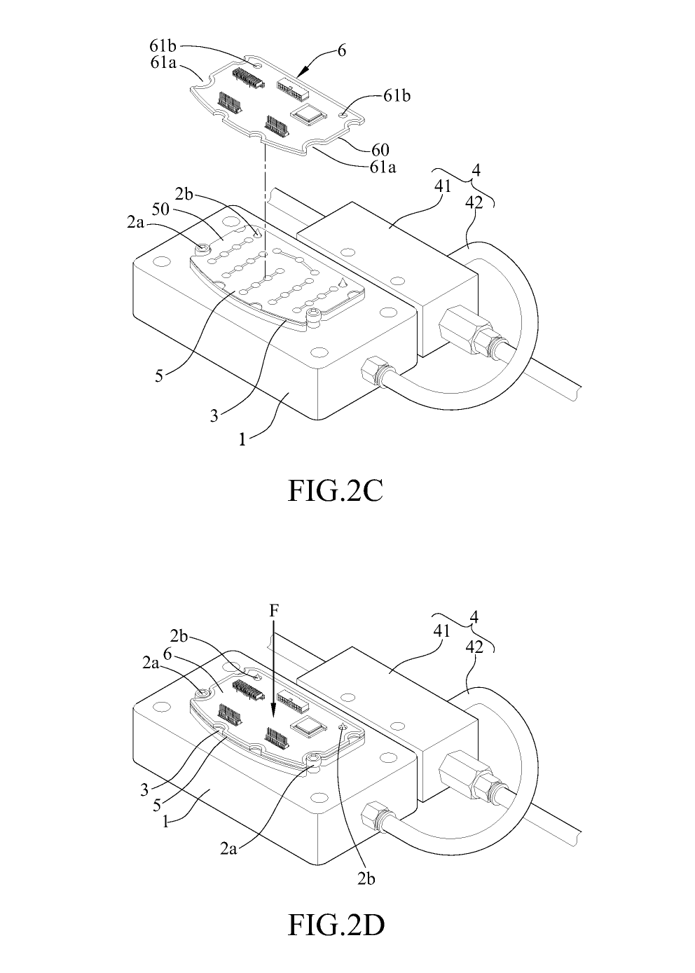

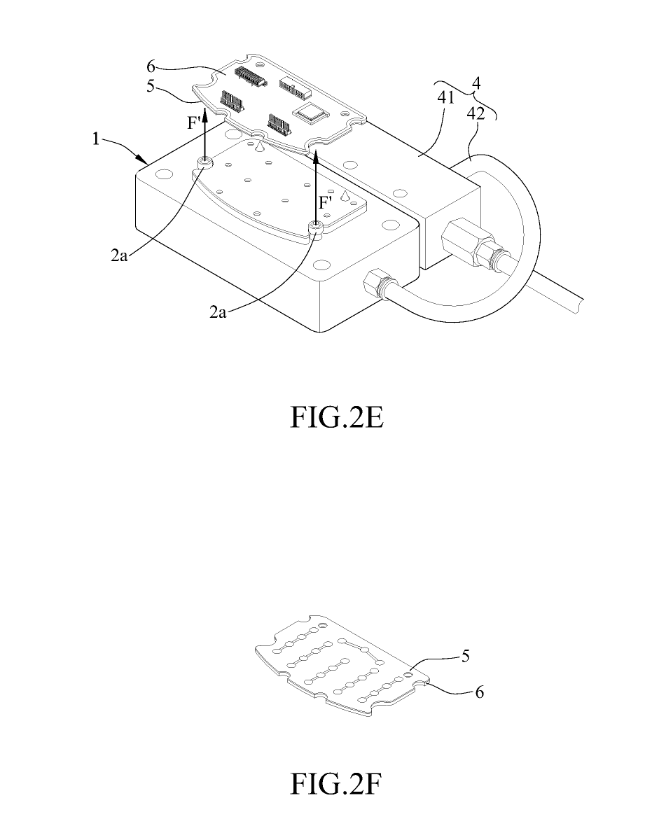

FIGS. 2A to 2F show a film pasting method according to the present invention.

Referring to FIG. 2A, a dome array 5 is positioned on the support member 3 through the first and second positioning members 2a and 2b of the carrier 1. The dome array 5 has a plurality of metal dome contacts 52a, and a first positioning hole 51a and a second positioning hole 5 lb corresponding to the first positioning member 2a and the second positioning member 2b, respectively. The first positioning hole 51a and the second positioning hole 51b are engaged with the first positioning member 2a and the second positioning member 2b, respectively, so as to position the dome array 5 on the support member 3. In an embodiment, the first and second positioning members 2a, 2b have cone shapes.

Referring to FIG. 2B, the suction member 4 provides a suction force that sucks the dome array 5 through the at least one suction hole 12 of the carrier 1 and the plurality of air holes 32 of the support member 3 so as for the dome array 5 to be evenly disposed on the support member 3. Further, when the dome array 5 is disposed on the support member 3 and a suction operation is performed by the suction member 4, a release layer 53 covering an adhesive surface 50 of the dome array 5 is removed to expose the adhesive surface 50 of the dome array 5.

Then, referring to FIG. 2C, a circuit board 6 is disposed on the dome array 5 with its first and second positioning holes 61a, 61b engaged with the first and second positioning members 2a, 2b of the carrier 1. The active surface 60 of the circuit board 6 is cleaned first and then disposed on the adhesive surface 50 of the dome array 5. In an embodiment, the first and second positioning holes 61a, 61b of the circuit board 6 correspond to the first and second positioning members 2a and 2b, respectively.

Referring to FIG. 2D, a pressing force F is provided to press the circuit board 6 to the dome array 5. Further, after the pressing force F is removed, since the first and second positioning members 2a, 2b have cone shapes and are elastic and the first and second positioning holes 51a, 51b of the dome array 5 are greater than the first and second positioning holes 61a, 61b of the circuit board 6, an elastic restoring force F′ provided by the first and second positioning members 2a, 2b drives the dome array 5 and the circuit board 6 to move up, thereby separating the dome array 5 and the circuit board 6 from the support member 3, as shown in FIG. 2E.

Finally, the circuit board 6 is closely attached to the dome array 5, as shown in FIG. 2F.

Therefore, since the dome array 5 is sucked by the suction member 4 so as to be evenly disposed on the support member 3, the circuit board 6 can be evenly attached to the dome array 5, thereby eliminating the need to align the dome array 5 with the circuit board 6.

According to the present invention, the dome array is first positioned on the support member through the first and/or second positioning member and evenly disposed on the support member through a suction force provided by the suction member. Then, the circuit board is disposed on the dome array and further pressed to the dome array through a pressing force. When the pressing force is removed, the dome array and the circuit board are separated from the support member through an elastic restoring force provided by the first and/or second positioning member. As such, the dome array and the circuit board are precisely aligned to each other and pasted together. Further, the amount of time the adhesive surface of the dome array is exposed to air is shortened to thereby prevent unwanted objects from being attached between the dome array and the circuit board. Therefore, the present invention overcomes the conventional difficulty of aligning the dome array with the circuit board, improves the operation performance and increases the product yield.

The above-described descriptions of the detailed embodiments are only to illustrate the preferred implementation according to the present invention, and it is not to limit the scope of the present invention. Accordingly, all modifications and variations completed by those with ordinary skill in the art should fall within the scope of present invention defined by the appended claims.

What is claimed is:

1. A film pasting device for pasting a circuit board and a dome array together, comprising:
a carrier having at least a suction hole;
a support member connected to the carrier so as for the dome array to be disposed thereon, wherein the support member has a plurality of air holes;
a suction member connected to the carrier for providing a suction force that sucks the dome array through the at least one suction hole of the carrier and the air holes of the support member such that the dome array is evenly disposed on the support member, thereby allowing the circuit board to be evenly attached to the dome array; and
a first positioning member disposed on the carrier, wherein a pressing force is provided to press the circuit board to the dome array and when the pressing force is removed, the first positioning member provides an elastic restoring force so as to separate the dome array and the circuit board from the support member.

2. The film pasting device of claim 1, further comprising an actuating member that provides the pressing force so as to press the circuit board to the dome array.

3. The film pasting device of claim 1, wherein the support member has a first positioning portion corresponding to the first positioning member.

4. The film pasting device of claim 1, further comprising at least a second positioning member disposed on the carrier and having elasticity, and at least a second positioning portion disposed on the support member and corresponding to the second positioning member.

5. The film pasting device of claim 4, wherein the first and second positioning members are cone-shaped positioning columns.

6. The film pasting device of claim 4, wherein the dome array has a first positioning hole and a second positioning hole corresponding to the first positioning member and the second positioning member, respectively, so as to position the dome array on the support member.

7. The film pasting device of claim 6, wherein the circuit board has a first positioning hole and a second positioning hole corresponding to the first positioning member and the second positioning member, respectively, so as to position the circuit board on the dome array.

8. The film pasting device of claim 7, wherein the first positioning hole of the dome array is greater than the first positioning hole of the circuit board, and the second positioning hole of the dome array is greater than the second positioning hole of the circuit board.

9. A film pasting method for pasting a circuit board and a dome array together, comprising the steps of:
(1) positioning the dome array;
(2) providing a suction force for sucking the dome array so as to evenly dispose the dome array;
(3) disposing the circuit board on the dome array; and
(4) providing a pressing force so as to press the circuit board to the dome array.

10. The film pasting method of claim 9, wherein the dome array has an adhesive surface covered with a release layer, and step (2) further comprises removing the release layer to expose the adhesive surface.
